(19) United States
(12) Patent Application Publication
(10) Pub. No.: US 2022/0164023 A1
(43) Pub. Date: May 26, 2022

(54) DYNAMICALLY SWITCHING USER INPUT DEVICES

(71) Applicant: INTERNATIONAL BUSINESS MACHINES CORPORATION, ARMONK, NY (US)

(72) Inventors: Ahmed Nassar, Pflugerville, TX (US); Scott Nidell, Georgetown, TX (US); Matthew Harrison Tong, Austin, TX (US); Neeraj Madan, Little Elm, TX (US)

(21) Appl. No.: 17/102,590

(22) Filed: Nov. 24, 2020

(51) Int. Cl. G06F 3/01; G06K 9/62; G06K 9/00

(52) U.S. Cl. CPC G06F 3/011; G06K 9/00664; G06K 9/6201

(57) ABSTRACT

A method, computer-program product, and system is provided. Separate computing devices can be controlled with one or more user input devices linked to the separate computing devices by an application. An image of a display from one of the linked computing devices can be captured with a smart headset and can be compared to display outputs retrieved from linked computing devices and the user input device can be activated one the corresponding linked computing device.

### BACKGROUND OF THE INVENTION

The present invention relates generally to user input devices, and more specifically, to dynamically switching user input devices between separate computing devices.

To effectuate a command, computing devices require input from a user in one manner or another. The most common method of user input is interaction with a graphical user interface, through a user input device. Often, a user can be operating multiple computing devices.

### SUMMARY

Embodiments of the present disclosure include a method, computer program product, and system for dynamically switching user input devices between computing devices. A processor can receive a real-time image of a display. A processor can retrieve snapshots of current displays of linked computing devices. A processor can analyze the real-time image of the display and the snapshots. A processor can determine which of the snapshots corresponds to the real-time image of the display, based on the analyzing. A processor can activate a UICD on the computing device that produced the snapshot, from the linked computing devices, based on the determining.

The above summary is not intended to describe each illustration or every implementation of the present disclosure.

### BRIEF DESCRIPTION OF THE DRAWINGS

FIG. 1 is a functional block diagram generally depicting an environment for dynamically switching user input devices between separate computing devices, in accordance with an embodiment of the present invention;

FIG. 2 is a functional block diagram depicting a user input device switch engine, in accordance with an embodiment of the present invention;

FIG. 3 is a flowchart depicting operational steps of a method for dynamically switching user input devices between separate computing devices, in accordance with an embodiment of the present invention; and

FIG. 4 is a functional block diagram of components of an exemplary computer within a dynamically switching user input device between computing systems, in accordance with an embodiment of the present invention.

FIG. 5 is a diagram depicting a cloud computing environment, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted and described herein recognize the need for dynamically switching user input devices between separate computing devices.

In one embodiment of the invention, a user can operate a smart headset. The smart headset can be linked to at least two separate computing devices with corresponding displays. The smart headset can also be linked to a user input device, such as a mouse and/or keyboard or one of the computing devices. The smart headset can capture images of a display based on the direction the user's head is oriented. In another aspect, snapshots of the display output of linked computing devices can be retrieved. It should be noted that in one embodiment the snapshots can be retrieved by a software program. The real-time video images can be compared to the snapshots to determine which display the user is focused on. The user input device can then be communicatively connected to the computing device associated with the display on which the user is focusing and allow for interaction with the graphical user interface (GUI).

In another embodiment, a user can operate a virtual reality headset. The headset may be linked to multiple local and remote computing devices. The virtual reality headset can allow for projections of one or more computing devices GUI within the virtual reality environment. The virtual reality headset can transmit the GUI the user is focused on, within the virtual reality environment, to the user input device switching engine, depending on the orientation of the user's focus. A user input device can then be activated on the computing device with the associated GUI the user is currently focusing on. It should be noted that a switching application can perform the activation. The user input device may be a virtual reality paint device, smart writing device, virtual reality control device, etc., capable of interaction within a GUI environment.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

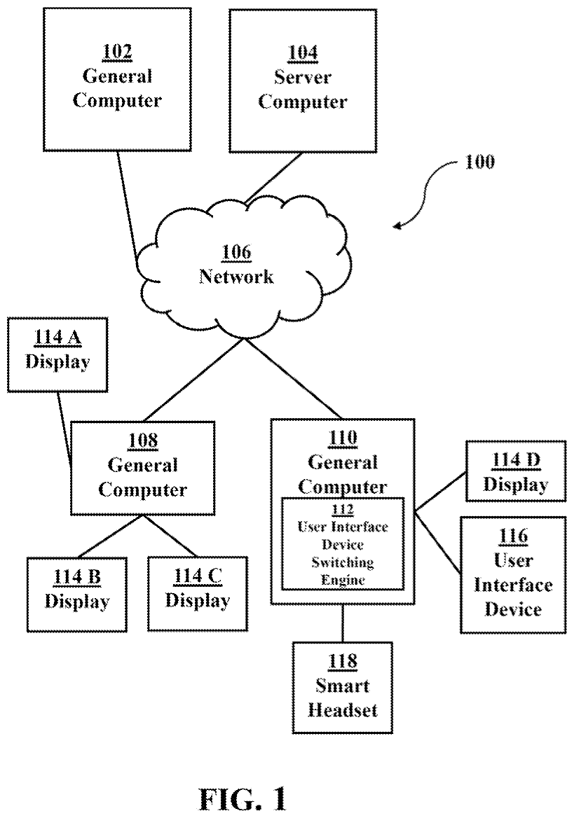

FIG. 1 is a functional block diagram illustrating, generally, an environment 100 for dynamically switching user input devices between separate computing devices. The environment 100 for dynamically switching user input devices between separate computing devices comprises general computers 102, 108, 110, server computer 104, network 106, displays 114A, 114B, 114C, and 114D, user input device switching engine (UIDSE) 112 operational on general computer 110, user input device 116, and smart headset 118.

General computers 102, 108, and 110 can be standalone computing devices, management servers, web servers, mobile computing devices, or any other electronic devices or computing systems capable of receiving, sending, and processing data. In other embodiments, general computers 102, 108, and 110 can represent server computing systems utilizing multiple computers as a server system. It should be noted that general computers 102, 108, 110 can also be referred to as “client computers.” In another embodiment, general computers 102, 108, and 110 can be a laptop computer, a tablet computer, a netbook computer, a personal computer, a desktop computer, or any programmable electronic device capable of communicating with other computing devices (not shown) within dynamic computing device user input device switching environment 100 via network 106. It should be noted, while three general computers 102, 108, and 110 are shown in FIG. 1, there can be any number of general computers within dynamic computing device user input device switching environment 100.

Server computer 104 can be a standalone computing device, management server, a web server, a mobile computing device, or any other electronic device or computing system capable of receiving, sending, and processing data. In other embodiments, server computer 104 can represent a server computing system utilizing multiple computers as a server system. In another embodiment, server computer 104 can be a laptop computer, a tablet computer, a netbook computer, a personal computer, a desktop computer, or any programmable electronic device capable of communicating with other computing devices (not shown) within the environment 100 for dynamically switching user input devices between separate computing devices via network 106. It should be noted, while one server computer is shown in FIG. 1, there can be any number of server computers within dynamic computing device user input device switching environment 100.

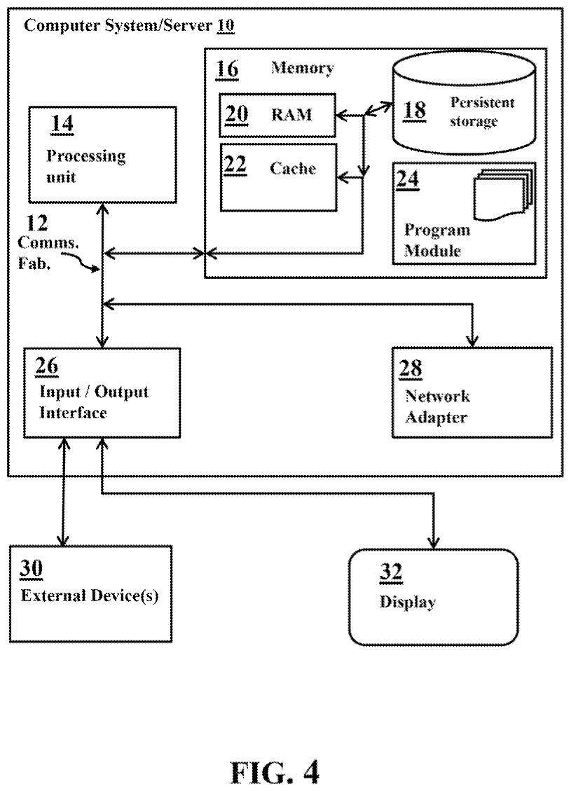

In another embodiment, server computer 104 resents a computing system utilizing clustered computers and components (e.g., database server computers, application server computers, etc.) that act as a single pool of seamless resources when accessed within the environment for dynamically switching user input devices between separate computing devices 100. Server computer 104 can include internal and external hardware components, as depicted and described in further detail with respect to FIG. 4.

Network 106 can be, for example, a local area network (LAN), a wide area network (WAN) such as the Internet, or a combination of the two, and can include wired, wireless, or fiber optic connections. In general, network 106 can be any combination of connections and protocols that will support communications between general computers 102, 108, 110, smart headset 118 (described further below), and server computer 104.

UIDSE 112 is shown operational on general computer 110. However, this is one embodiment and should not be construed to limit the device on which UIDSE 112 may be operational. For example, UIDSE 112 can be operational on server computer 104 or general computer 102, 108. Additionally, UIDSE 112 can be operational on smart headset 118. In general, UIDSE 112 can be operational on any device capable of communicating with other computing devices within the environment 100 for dynamically switching user input devices between separate computing devices via network 106. Further, UIDSE 112 can be operational on all linked computing devices, as peer instances, which can become subordinate to one another as needed. In some embodiments, one instance of UIDSE 112 can become the primary operational instance which retrieves display snapshots from the other linked computing devices and receives the image display capture from smart headset 118 (described further below) and utilizes the processor of the computing device on which the primary UIDSE 112 is operational. It should be noted, UIDSE 112 can have the capability to monitor the processing load of the computing device on which it is operational. If the primary instance UIDSE 112 detects high utilization of resources (e.g. central processing unit, graphics processing unit, memory, etc.) of the computing device on which it is operational, another instance of UIDSE 112 on a computing device with lower resource utilization can become the primary instance of UIDSE 112.

Display 114A, 114B, 114C, 114D can be a monitor, a television, a projector projecting on to a suitable surface to allow for visualization of a GUI, virtual reality headset (described further below), or any other electronic device capable of outputting a GUI for display. It should be noted, display 114A, 114B, 114C, 114D may be GUI units created within a virtual reality environment using a virtual reality headset and linked to remote or local computing systems. Further, while in FIG. 1 displays 114A, 114B, 114C are shown connected to general computer 108, this is for illustrative purposes as the displays can be connected to any computing device capable of producing a GUI, including local computing devices and remote computing, capable of producing a GUI.

Smart Headset 118 can be an augmented reality headset, for example, Hololens® by Microsoft®, Moverio® by Epson®, Blade® by Vuzix®, and Glass® by Google®. Further, Smart Headset 118 can be a virtual reality headset for example, Reverb by Hewlett Packard®, Oculus® by Facebook®, and PlayStation VR® by Sony®. Additionally, Smart headset 118 may be a smart phone or smart device, capable of operating virtual reality software and inserting into a headset allowing for a virtual reality experience, for example, Gear VR® by Samsung® and Daydream® by Google®. Smart headset 118 can have an optical receiver capable of capturing display output, for example, still images, video, and pixel data. Further, smart headset 118 can be worn by a user, but it is not required to be worn on the head, so long as smart headset 118 can determine which display the user is focused on and can obtain an image capture of the display. Smart headset 118 is shown connected to general computer 110, however this is for illustrative purposes only, as smart headset 118 can be connected to any computing device capable of communicating over network 106 or smart headset 118 can be directly connected to and communication over network 106 (not shown), provided smart headset 118 is in communication with UIDSE 112.

User input device 116 can be a keyboard, mouse, trackpad, joystick, video game controller, smart pencil, virtual reality paint device or other electronic device suitable for interacting with a GUI of a computing device. It should be noted, while user input device 116 is shown connected to general computer 110, this is for illustrative purposes only. User input device may be connected to any computing device or smart headset 118 that is capable of communicating with UIDSE 112.

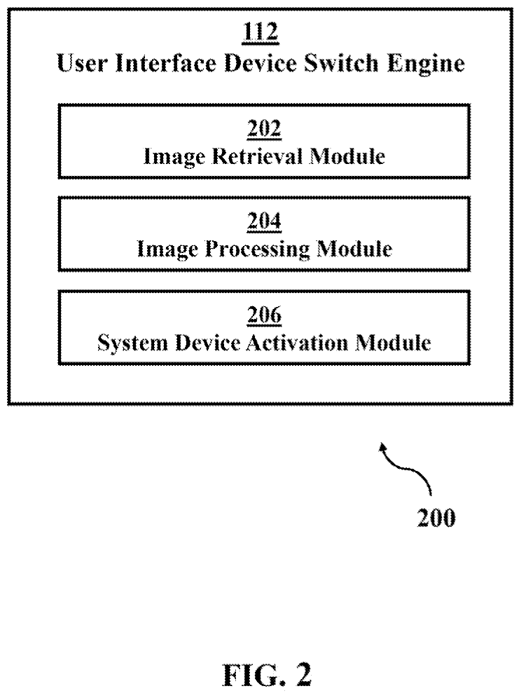

Now with reference to FIG. 2, a block diagram 200 comprising UIDSE 112 is depicted. Operational on UIDSE 112 is image retrieval module 202, image processing module 204, and system device activation module 206.

Image retrieval module 202 can provide a database of computing devices linked with UIDSE 112. For example, the database can comprise the internet protocol address and port address of computing devices with an operational peer instance of UIDSE 112. The database may have any identifying information associated with linked computing devices that can allow for the linked computing devices to be identified based on an image comparison and allow for communication between all instances of UIDSE 112. The retrieval of display snapshots can be accomplished over network 106 or other suitable means to communicatively link computing devices. Further, Image retrieval module 202 can receive captured display images from, for example, a smart headset 118. These captured display images may be local displays, remote displays, or a mix of local and remote displays, including, but not limited to displays created in a virtual environment.

Image processing module 204 can provide the capability to determine which display the user is looking at by analyzing captured images from smart headset 118 and the display output snapshots from linked computing devices retrieved by image retrieval module 202. In some embodiments, image processing module 204 can have functionality comprising optical recognition. In some embodiments of the present invention, image processing module 204 can analyze the headset images using optical recognition. For example, in some embodiments, the optical recognition may analyze the headset image for known landmarks on the display or GUI and calculate the viewing angle based on the current pixel data of the image and multi-axis directional sensors within smart headset 118. Additionally, there may be portions of multiple displays within the received images from smart headset 118. The optical recognition can calculate which display is in the majority of the one image and determine the display taking up the majority. Majority in the instant example can mean the display that is filling the greatest percentage of the images received from headset 118. Additionally, in some embodiments, majority could mean the display within the images received from the headset that is completely within the image, while the entirety of other displays may not be visible. Further, image processing module 204 can compare the captured display image to the display snapshots and can identify landmarks on the headset-captured display image and search for the corresponding landmark on the snapshots. This action analysis can be performed by a deep neural network (DNN) which searches for progressively larger pixel formations and correlates the landmarks between the display image capture and the display snapshots. It should be noted that the image processing module 204 can have a feedback loop in which continually updates the optical recognition model.

In other embodiments, image processing module 204 can calculate a snapshot confidence score. Image processing module 204 receives the output from image retrieval module 202, including the snapshots of the linked computing devices and the display image from smart headset 118. Due to potential variations in perspective of the user wearing headset 118 (e.g., the user is positioned below, to the right, to the left, or above the display, etc.) display output conditions (e.g. contrast, brightness, blue light reduction, etc.), or multiple displays within the headset display image, it may be difficult to receive an accurate replica of the corresponding display snapshot from the linked computing device. Accordingly, image processing module 204 can use a DNN trained with an optical recognition model to scan the headset display image for known landmarks, including, but not limited to, display boarders, display size, display resolution, known operating system GUI layout, application GUI layout, etc. Additionally, the DNN can have a feedback loop, allowing determination of the percentage of time a user is focused on a specific screen and add additional weight to the determination of the highly used screen. For example, in some embodiments image processing module 204 can have the capability to keep a real time clock running of which displays are active within allowing weights to be modified within the DNN accordingly, ensuring that the most utilized displays are activated more often. Further, the DNN can compare landmarks discovered by an analysis scan of the display capture image to the display snapshots. For example, but not limited to, the DNN can compare for the expected location of colors within the snapshots, the displacement of colors within the snapshot, and known artifacts of programs executing on computing devices. Further, a confidence score can be, but is not limited to, an Fi score based on the difference between the display image capture and the display snapshots.

Further, in some embodiments, once a user input device 116 has been activated on a computing device, the image retrieval module 202 can retrieve a snapshot of the display output of the activated computing device, once a command has been received from user input device. For example, in some embodiments, a user input device 116 may transmit mouse movement to the active computing device, moving a pointer across the display linked to the active computing device. Smart headset 118 will capture an image of the mouse movement and a snapshot from the active computing device will be retrieved. The two images will be compared to each other by tracking the movement of the pointer to confirm the correct computing device has been activated. Image retrieval module 202 will also receive an updated display image capture from headset 118. Image recognition module 204 will analyze the display snapshot from the active computing device to the headset image to ensure the user input device 116 has been activated on the correct computing device has been activated.

System device activation module 206 receives the results of the output of image recognition module 204 and activates user input device 116 on the computing device associated with the snapshot that corresponds to the headset image. In some embodiments of the present invention, system device activation module 206 can activate the user input device if the confidence score exceeds a predetermined threshold, for example 85% confidence. Additionally, if more than one display snapshot exceeds the threshold confidence score, the user input devices can be activated on the computing device associated with the display snapshot that received the highest confidence score. The activation can be accomplished by transmitting a command from system device activation module 206 to the computing device which is linked by the UIDSE 112 program. The command configures the linked user input device to operate on the GUI of the activated computing device. Once the command has been received by the activated computing device, the computing device will continue to accept inputs until a command to stop receiving inputs is transmitted to the active computing device by UISDE 112. The active computing device will receive a command to stop receiving inputs from UISDE 112 once image recognition module 204 detects a new display image that is not confirmed by image processing module 204 or there is user head motion detected by smart headset 118. Further, the user can lock the user input device 116 to a screen once it is activated, for example, by verbally commanding a digital assistant associated with the computing device operating the primary UIDSE 112 (e.g. Cortana® by Microsoft®, Ski® by Apple®, Bixby® by Samsung®, etc.), engaging an object within the GUI, or engaging a button or touch enabled artifact on smart headset 118.

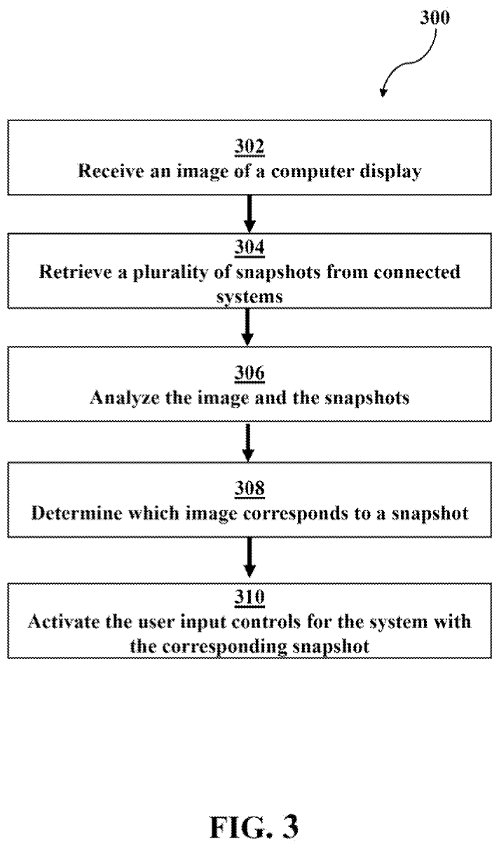

FIG. 3 is a flowchart of a method 300 depicting operational steps to dynamically switch user input devices between separate computing devices. At step 302, smart headset 118 captures a display image (from 114A, 114B, 114C, or 114D) and sends the display image capture to image retrieval module 202. Next, at step 304, image retrieval module 202 retrieves a plurality of display snapshots from linked computing devices 102 104 108, or 110. Next, at step 306, image processing module 204 analyzes the display image capture and the display snapshots. Next at step 308, image processing module determines which display snapshot corresponds to the display image capture. Next, at step 310 system device activation module 206 activates user input device 116 on the computing device that is associated with the corresponding display image.

FIG. 4 depicts computer system 10, an example computer system representative of a dynamically switching user interface computer 10. Computer system 10 includes communications fabric 12, which provides communications between computer processor(s) 14, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Computer system 10 includes processors 14, cache 22, memory 16, persistent storage 18, network adaptor 28, input/output (I/O) interface(s) 26 and communications fabric 12. Communications fabric 12 provides communications between cache 22, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses or a crossbar switch.

Memory 16 and persistent storage 18 are computer readable storage media. In this embodiment, memory 16 includes random access memory (RAM). In general, memory 16 can include any suitable volatile or non-volatile computer readable storage media. Cache 22 is a fast memory that enhances the performance of processors 14 by holding recently accessed data, and data near recently accessed data, from memory 16.

Program instructions and data used to practice embodiments of the present invention may be stored in persistent storage 18 and in memory 16 for execution by one or more of the respective processors 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network adaptor 28, in these examples, provides for communications with other data processing systems or devices. In these examples, network adaptor 28 includes one or more network interface cards. Network adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connect to display 32.

Display 32 provides a mechanism to display data to a user and may be, for example, a computer monitor or virtual graphical user interface.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

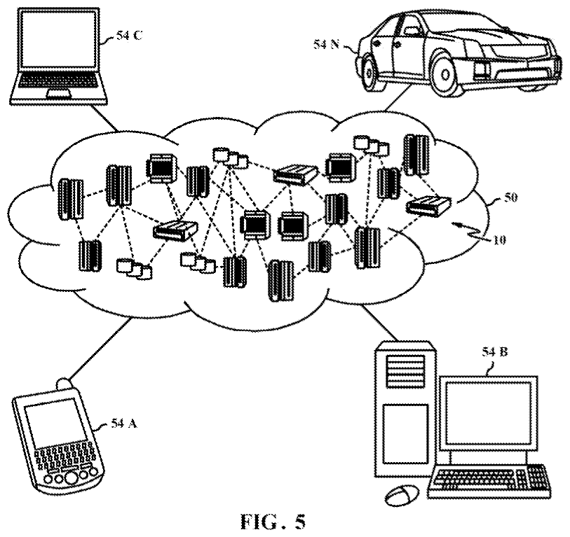

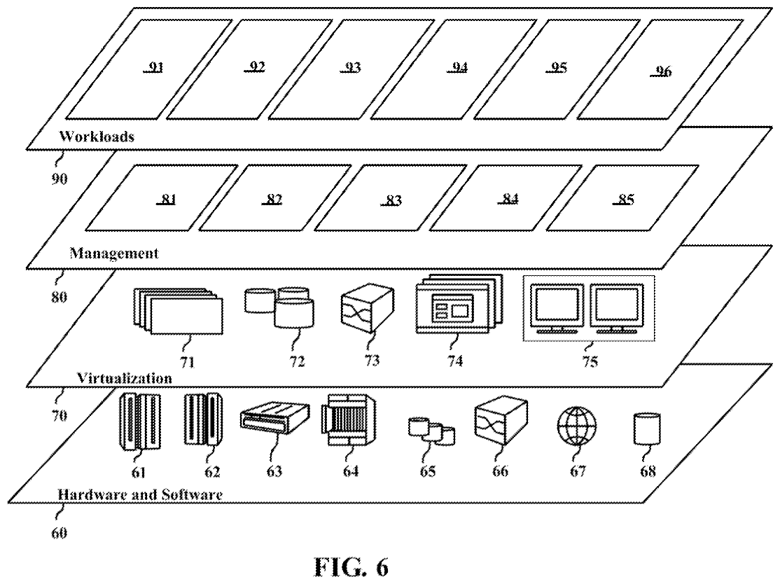

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

FIG. 6 is a block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamically switching user input device application 96.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for dynamically switching user input devices (UID) between separate computing devices, the method comprising:
receiving, by one or more processors, a real-time image of a display;
retrieving, by the one or more processors, snapshots of current displays of linked computing devices;
analyzing, by the one or more processors, the real-time image of the display and the snapshots;
determining, by the one or more processors, which of the snapshots corresponds to the real-time image of the display, based on the analyzing; and
activating, by the one or more processors, a UID on the computing device that produced the snapshot, from the linked computing devices, based on the determining.

2. The computer-implemented method of claim 1, further comprising:
comparing, by the one or more processors, a second real-time image from the computing device on which the UID has been activated, to a snapshot of the display from the computing device the UID has been activated on after a command has been entered with the UID; and
determining, by the one or more processors, if the UID has been activated on the correct computing device based on the comparing.

3. The computer-implemented method of claim 1, further comprising:
calculating, by the one or more processors, a snapshot confidence score based on the analyzing; and
activating, by the one or more processors, the UID on a computing system that produced the snapshot of the with the highest snapshot confidence score.

4. The computer-implemented method of claim 1, wherein:
the real-time image is received using a smart headset.

5. The computer-implemented method of claim 1, wherein:
the analyzing is performed by an optic recognition model.

6. The computer-implemented method of claim 5, further comprising:
analyzing, by the one or more processors, the real-time image; and
determining, by the one or more processors, if the real-time image is of a linked computer display, based on the analyzing.

7. The computer-implemented method of claim 1, wherein:
the UID is comprised of at least one of the following: a mouse, a keyboard, a trackpad, virtual paint device, or a smart writing instrument.

8. A computer system for dynamically switching user input devices (UIDs) between separate computing systems, the system comprising:
one or more computer processors;
one or more computer readable storage media;
computer program instructions;
the computer program instructions being stored on the one or more computer readable storage media for execution by the one or more computer processors; and the computer program instructions including instructions to:
receive a real-time image of a display;
retrieve snapshots of current displays of linked computing devices;
analyze the real-time image of the display and the snapshots;
determine which of the snapshots corresponds to the real-time image of the display, based on the analyzing; and
activate a UID on the computing device that produced the snapshot, from the linked computing devices, based on the determining.

9. The computer system of claim 8, further comprising program instructions to:
compare a second real-time image from the computing device on which the UID has been activated, to a snapshot of the display from the computing device the user input device has been activated on after a command has been entered with the UID; and
determine if the UID has been activated on the correct computing device, based on the comparing.

10. The computer system of claim 8, further comprising program instructions to:
calculate a snapshot confidence score based on the analyzing; and
activate the UID on a computing device that produced the snapshot with the highest snapshot confidence score.

11. The computer system of claim 8, wherein:
the real-time image is received using a smart headset.

12. The computer system of claim 8, wherein:
the analyzing is performed by an optic recognition model.

13. The computer system of claim 8, further comprising program instructions to:
analyze the real-time image; and
determining if the real-time image is of a linked computer display, based on the analyzing.

14. The computer system of claim 8, wherein:
the UID is comprised of at least one of the following: a mouse, a keyboard, a trackpad, virtual paint device, or a smart writing instrument.

15. A computer program product for dynamically switching user input devices (UIDs) between separate computing systems, the computer program product comprising one or more computer readable storage media and program instructions sorted on the one or more computer readable storage media, the program instructions including instructions to:
receive a real-time image of a display;
retrieve snapshots of the current displays of linked computing systems;
analyze the real-time image of the display and the snapshots;
determine which of the snapshots corresponds to the real-time image of the display, based on the analyzing; and
activate a UID on a computing device that produced the snapshot, from the linked computing devices, based on the determining.

16. The computer program product of claim 15, further comprising program instructions to:
compare a second real-time image from the computing device on which the UID has been activated to a snapshot of the display from the computing device the UID has been activated on after a command has been entered with the UID; and
determine if the UID has been activated on the correct computing device, based on the comparing.

17. The computer program product of claim 15, further comprising program instructions to:
calculate a snapshot confidence score based on the analyzing; and
activate the UID on a computing system that produced the snapshot of the currently displayed display with the highest snapshot confidence score.

18. The computer program product of claim 15, wherein:
the real-time image is received using a smart headset.

19. The computer program product of claim 15, further wherein:
the analyzing is performed by an optic recognition model.

20. The computer program product of claim 18, wherein:
the UID is comprised of at least one of the following: a mouse, a keyboard, a trackpad, virtual paint device, or a smart writing instrument.
